(19) United States
(12) Patent Application Publication
(10) Pub. No.: US 2026/0208955 A1
(43) Pub. Date: Jul. 23, 2026

(54) ROBOTIC PICKING AND CONVEYOR SYSTEM

(71) Applicant: Autostore Technology AS, Nedre Vats (NO)

(72) Inventor: Jørgen Djuve Heggebø, Langhus (NO)

(73) Assignee: Autostore Technology AS, Nedre Vats (NO)

(21) Appl. No.: 19/141,027

(22) PCT Filed: Dec. 20, 2023
(86) PCT No.: PCT/EP2023/087006

§ 371 Date: Jun. 18, 2025

(30) Foreign Application Priority Data
Dec. 21, 2022 (NO) 20221379

(51) Int. Cl. B65G 1/137; B25J 9/00; B65G 1/04; G06Q 10/087

(52) U.S. Cl. CPC B65G 1/1378; B25J 9/0093; B65G 1/0464; G06Q 10/08741

(57) ABSTRACT

An automated picking system and method for picking to and from containers in an automated storage and retrieval system wherein the automated storage and retrieval system comprises a rail system comprising a first set of parallel rails arranged to guide movement of a container handling vehicle in a first direction across a frame structure, and a second set of parallel rails arranged perpendicular to the first set of rails to guide movement of the container handling vehicle in a second direction which is perpendicular to the first direction, the first and second sets of parallel rails dividing the rail system into a plurality of grid cells having access openings, for storing storage containers in which items can be stored, and that the automated picking system comprises an automated picking arm situated in the access opening of a grid cell that is configured to pick items to and from containers situated in adjacent grid cells, and a conveyor system which is situated in columns of the adjacent grid cells to the automated picking arm for transporting containers to and from a picking zone, a pick-up point and/or a delivery point of the conveyor system of the automated picking system.

### FIELD OF THE INVENTION

The present invention relates to an automated storage and retrieval system for storage and retrieval of containers, in particular to a system and method for an automated picking system with a conveyor system.

### BACKGROUND AND PRIOR ART

FIG. 1 discloses a prior art automated storage and retrieval system 1 with a framework structure 100 and FIGS. 2, 3 and 4 disclose three different prior art container handling vehicles 201,301,401 suitable for operating on such a system 1.

The framework structure 100 comprises upright members 102 and a storage volume comprising storage columns 105 arranged in rows between the upright members 102. In these storage columns 105 storage containers 106, also known as bins, are stacked one on top of one another to form stacks 107. The members 102 may typically be made of metal, e.g. extruded aluminum profiles.

The framework structure 100 of the automated storage and retrieval system 1 comprises a rail system 108 arranged across the top of framework structure 100, on which rail system 108 a plurality of container handling vehicles 201,301,401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301,401 in a first direction X across the top of the frame structure 100, and a second set of parallel rails 111 arranged perpendicular to the first set of rails 110 to guide movement of the container handling vehicles 201,301,401 in a second direction Y which is perpendicular to the first direction X. Containers 106 stored in the columns 105 are accessed by the container handling vehicles 201,301,401 through access openings 112 in the rail system 108. The container handling vehicles 201,301,401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supporting.

Each prior art container handling vehicle 201,301,401 comprises a vehicle body 201a,301a,401a and first and second sets of wheels 201b, 201c, 301b, 301c,401b,401c which enable the lateral movement of the container handling vehicles 201,301,401 in the X direction and in the Y direction, respectively. In FIGS. 2, 3 and 4 two wheels in each set are fully visible. The first set of wheels 201b,301b,401b is arranged to engage with two adjacent rails of the first set 110 of rails, and the second set of wheels 201c,301c,401c is arranged to engage with two adjacent rails of the second set 111 of rails. At least one of the sets of wheels 201b, 201c, 301b,301c,401b,401c can be lifted and lowered, so that the first set of wheels 201b,301b,401b and/or the second set of wheels 201c,301c,401c can be engaged with the respective set of rails 110, 111 at any one time.

Each prior art container handling vehicle 201,301,401 also comprises a lifting device for vertical transportation of storage containers 106, e.g. raising a storage container 106 from, and lowering a storage container 106 into, a storage column 105. The lifting device comprises one or more gripping/engaging devices which are adapted to engage a storage container 106, and which gripping/engaging devices can be lowered from the vehicle 201,301,401 so that the position of the gripping/engaging devices with respect to the vehicle 201,301,401 can be adjusted in a third direction Z which is orthogonal the first direction X and the second direction Y. Parts of the gripping device of the container handling vehicles 301,401 are shown in FIGS. 3 and 4 indicated with reference number 304,404. The gripping device of the container handling device 201 is located within the vehicle body 201a in FIG. 2 and is thus not shown.

Conventionally, and also for the purpose of this application, Z=1 identifies the uppermost layer available for storage containers below the rails 110,111, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=17, Y=1, Z=6. The container handling vehicles 201,301,401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as storage cells. Each storage column may be identified by a position in an X-and Y-direction, while each storage cell may be identified by a container number in the X-, Y- and Z-direction.

Each prior art container handling vehicle 201,301,401 comprises a storage compartment or space for receiving and stowing a storage container 106 when transporting the storage container 106 across the rail system 108. The storage space may comprise a cavity arranged internally within the vehicle body 201a,401a as shown in FIGS. 2 and 4 and as described in e.g. WO2015/193278A1 and WO2019/206487A1, the contents of which are incorporated herein by reference.

FIG. 3 shows an alternative configuration of a container handling vehicle 301 with a cantilever construction. Such a vehicle is described in detail in e.g. NO317366, the contents of which are also incorporated herein by reference.

The cavity container handling vehicle 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference.

The term ‘lateral’used herein may mean ‘horizontal’.

Alternatively, the cavity container handling vehicles 401 may have a footprint which is larger than the lateral area defined by a storage column 105 as shown in FIGS. 1 and 4, e.g. as is disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing.

These grooves and upwardly protruding elements are collectively known as tracks. Each rail may comprise one track, or each rail 110,111 may comprise two parallel tracks. In other rail systems 108, each rail in one direction (e.g. an X direction) may comprise one track and each rail in the other, perpendicular direction (e.g. a Y direction) may comprise two tracks. Each rail 110,111 may also comprise two track members that are fastened together, each track member providing one of a pair of tracks provided by each rail.

WO2018/146304A1, the contents of which are incorporated herein by reference, illustrates a typical configuration of rail system 108 comprising rails and parallel tracks in both X and Y directions.

In the framework structure 100, a majority of the columns 105 are storage columns 105, i.e. columns 105 where storage containers 106 are stored in stacks 107.

However, some columns 105 may have other purposes. In FIG. 1, columns 119 and 120 are such special-purpose columns used by the container handling vehicles 201,301,401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119,120 for further transportation to an access station. The transportation from the port to the access station may require movement along various different directions, by means such as delivery vehicles, trolleys or other transportation lines. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201,301,401 can drop off storage containers 106 to be transported to an access or a transfer station, and the second port column 120 may be a dedicated pick-up port column where the container handling vehicles 201,301,401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1, but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119,120 and the access station.

If the port columns 119,120 and the access station are located at different levels, the conveyor system may comprise a lift device with a vertical component for transporting the storage containers 106 vertically between the port column 119,120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 201,301,401 is instructed to retrieve the target storage container 106 from its position and transport it to the drop-off port column 119. This operation involves moving the container handling vehicle 201,301,401 to a location above the storage column 105 in which the target storage container 106 is positioned, retrieving the storage container 106 from the storage column 105 using the container handling vehicle's 201,301,401 lifting device (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201,301,401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201,301,401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201,301,401 positions the storage container 106 at the desired position. The removed storage containers 106 may then be lowered back into the storage column 105 or relocated to other storage columns 105.

For monitoring and controlling the automated storage and retrieval system 1, e.g.

monitoring and controlling the location of respective storage containers 106 within the framework structure 100, the content of each storage container 106, and the movement of the container handling vehicles 201,301,401 so that a desired storage container 106 can be delivered to the desired location at the desired time without the container handling vehicles 201,301,401 colliding with each other, the automated storage and retrieval system 1 comprises a control system 500 which typically is computerized and which typically comprises a database for keeping track of the storage containers 106.

Picking items from containers in a storage and retrieval system can be a slow process due to human involvement. Humans need to have breaks and the picking speed might vary from person to person. Also, the container handling vehicles has to transport all the necessary containers from the grid to the port and back again.

This can be time consuming if the amount of orders that needs to be processed is a lot. It is therefore a need for a system that is capable of Also there might at times be a need for additional picking capacity at certain times of the year.

### SUMMARY OF THE INVENTION

The present invention is set forth and characterized in the independent claims, while the dependent claims describe other characteristics of the invention.

The present invention relates to an automated picking system for picking to and from containers in an automated storage and retrieval system wherein the automated storage and retrieval system comprises a rail system comprising a first set of parallel rails arranged to guide movement of a container handling vehicle in a first direction across a frame structure, and a second set of parallel rails arranged perpendicular to the first set of rails to guide movement of the container handling vehicle in a second direction which is perpendicular to the first direction, the first and second sets of parallel rails dividing the rail system into a plurality of grid cells having access openings, for storing storage containers in which items can be stored, and characterized in that the automated picking system comprises an automated picking arm situated in the access opening of a grid cell that is configured to pick items to and from containers situated in adjacent grid cells, and a conveyor system which is situated in columns of the adjacent grid cells to the automated picking arm for transporting containers to and from a picking zone, a pick-up point and/or a delivery point of the conveyor system of the automated picking system.

In one aspect, the system takes up from 3×3 to 5×5 grid cells.

In one aspect, a picking zone of 2×3 grid cells of the system is surrounded by walls positioned at the outer edges of the conveyor system in the grid spaces of the picking zone.

In one aspect, the conveyor system is situated in a stacking level which is located just below the access opening of the grid cells on the grid

In one aspect the conveyor system is situated at a level of the access opening of the cells on the grid

In one aspect the delivering point and the pick-up point of containers are the same grid cell.

In one aspect, the delivering point and the pick-up point of containers are neighboring grid cells.

In one aspect, each cell has its own part of the conveyor system that can be controlled independent of the other parts of the conveyor system of the other grid cells.

In one aspect, the conveyor system can be rollers or belts.

In one aspect, the conveyor system can transport the container from one cell into a neighboring cell with a conveyor system.

In one aspect, along the outer most edge of the conveyor system there is positioned stoppers to prevent the containers from moving outside the conveyor system.

In one aspect, the stoppers can be blocks or an upright edge running the entire perimeter of the conveyor system.

In one aspect, each part of the conveyor system is controlled by the central computer system.

In one aspect, each part of the conveyor system is this size of a grid cell.

In one aspect, the arm can extend the just below the access opening of the grid cells on the grid.

The present invention relates to a method for picking at an automated picking system placed for picking to and from containers in an automated storage and retrieval system wherein the automated storage and retrieval system comprises a rail system comprising a first set of parallel rails arranged to guide movement of a container handling vehicle in a first direction across a frame structure, and a second set of parallel rails arranged perpendicular to the first set of rails to guide movement of the container handling vehicle in a second direction which is perpendicular to the first direction, the first and second sets of parallel rails dividing the rail system into a plurality of grid cells having access openings, for storing storage containers for storing items and wherein the method comprises the following steps: transporting source containers and/or target containers to a delivering point in the automated picking system using container handling vehicles, transporting the source container and/or the target container from the delivering point to a picking zone using a conveyor system, picking one or more items from one or more source containers using an automated picking arm, placing the one or more picked items in the one or more target containers using the automated picking arm, transporting the source containers and the target containers from the picking zone to a pick-up point when finished using the conveyor system, and transporting the containers from the pick-up point of the system to the container's designated area using container handling vehicles.

In one aspect, the method includes delivering the source containers back into the frame structure for storage after picking using container handling vehicles.

In one aspect, the method includes delivering the target containers to ports for further distribution after picking.

In one aspect, the containers are lowered into/raised up through one stacking level onto/off the conveyor.

In one aspect, the containers are lowered into/raised up through two stacking levels onto/off the conveyor.

The present invention also relates to a computer program product that when executed in a processor by a central computer system is arranged to control a picking arm and a conveyor system for picking at an automated picking system placed for picking to and from containers in an automated storage and retrieval system performs the steps of: transporting container from the storage and retrieval system to the conveyor system using a container handling vehicle, maneuvering the container to the right position in the automated picking system using the conveyor system, using the picking arm to pick an item stored in a source container and deliver it to a target container, using a container handling vehicle to pick up the source container when the required items have been picked.

The present invention also relates to an automated storage and retrieval system comprising a framework structure with a rail system comprising a first set of parallel rails arranged to guide movement of a container handling vehicle in a first direction across a frame structure, and a second set of parallel rails arranged perpendicular to the first set of rails to guide movement of the container handling vehicle in a second direction which is perpendicular to the first direction, the first and second sets of parallel rails dividing the rail system into a plurality of grid cells having access openings, for storing storage containers in which items can be stored, forming vertical columns each having a horizontal area defined by the size of an access opening between rails of the rail system that are arranged on the framework structure, and wherein the automated storage and retrieval system is controlled by a central computer system, characterized in that system further comprises an automated picking system comprising an automated picking arm situated in the access opening of a grid cell that is configured to pick items to and from containers situated in adjacent grid cells, and a conveyor system which is situated in columns of the adjacent grid cells to the automated picking arm for transporting containers to and from a picking zone, a pick-up point and/or a delivery point of the conveyor system of the automated picking system.

The robotic arm can make the job easier for the operators at the port. The robotic arm can be used to pick out orders at the grid and then send the ready picked orders to the ports for further distribution vastly reducing the time needed for picking orders. The robotic arm can work continuously and faster than a human and with fewer mistakes.

### BRIEF DESCRIPTION OF THE DRAWINGS

Following drawings are appended to facilitate the understanding of the invention. The drawings show embodiments of the invention, which will now be described by way of example only, where:

FIG. 1 is a perspective view of a framework structure of a prior art automated storage and retrieval system.

FIG. 2 is a perspective view of a prior art container handling vehicle having an internally arranged cavity for carrying storage containers therein.

FIG. 3 is a perspective view of a prior art container handling vehicle having a cantilever for carrying storage containers underneath.

FIG. 4 is a perspective view, seen from below, of a prior art container handling vehicle having an internally arranged cavity for carrying storage containers therein.

FIG. 5a-d is a display of an embodiment of the present invention from different angles.

FIG. 6a-d is a display of a different embodiment of the present invention from different angles.

FIG. 7a-c is a display of different solutions to the conveyor system.

FIG. 8a-c is different views of another embodiment of the present invention where there are more than one automated picking arm.

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

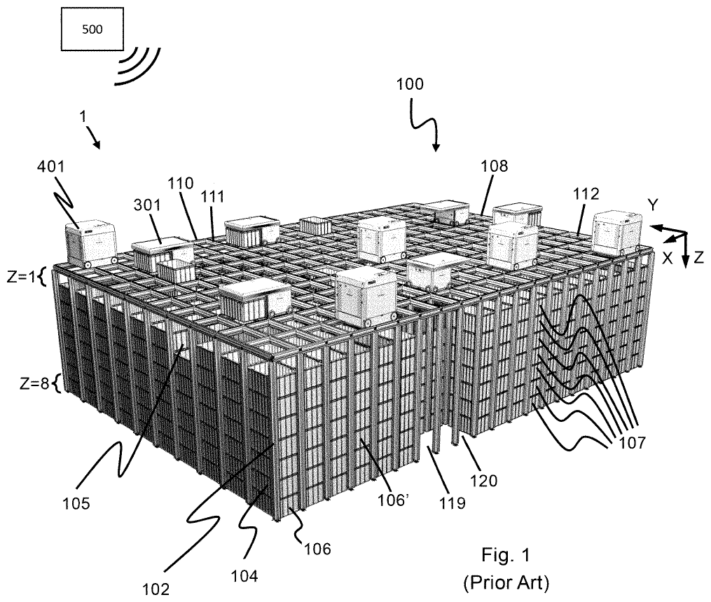

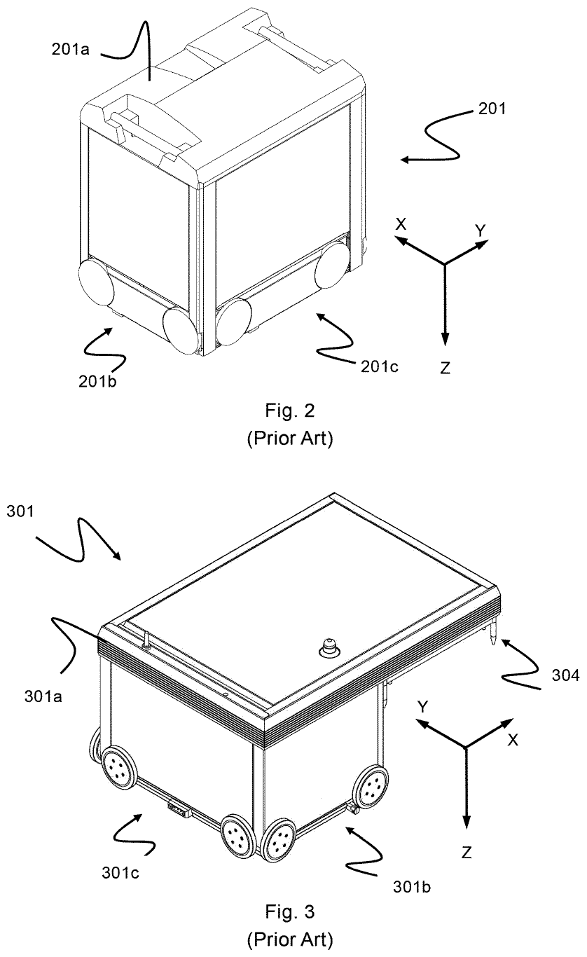

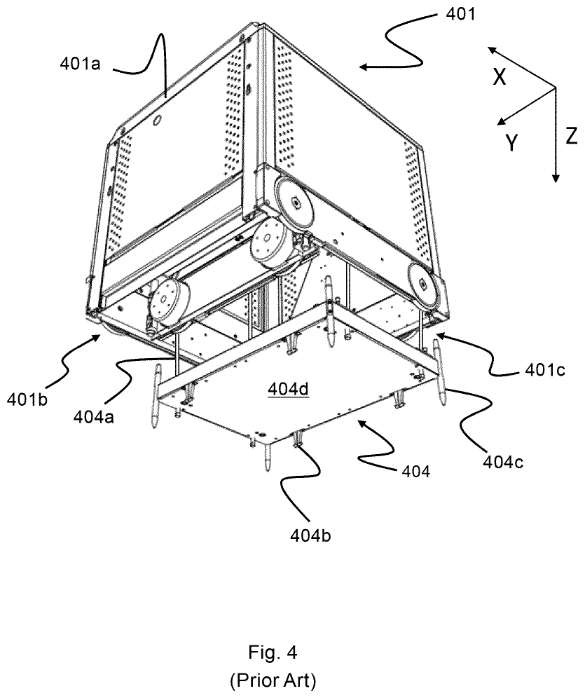

The framework structure 100 of the automated storage and retrieval system 1 is constructed in a similar manner to the prior art framework structure 100 described above in connection with FIGS. 1-3. That is, the framework structure 100 comprises a number of upright members 102, and comprises a first, upper rail system 108 extending in the X direction and Y direction.

The framework structure 100 further comprises storage compartments in the form of storage columns 105 provided between the members 102 wherein storage containers 106 are stackable in stacks 107 within the storage columns 105.

The framework structure 100 can be of any size. In particular it is understood that the framework structure can be considerably wider and/or longer and/or deeper than disclosed in FIG. 1. For example, the framework structure 100 may have a horizontal extent of more than 700×700 columns and a storage depth of more than twelve containers.

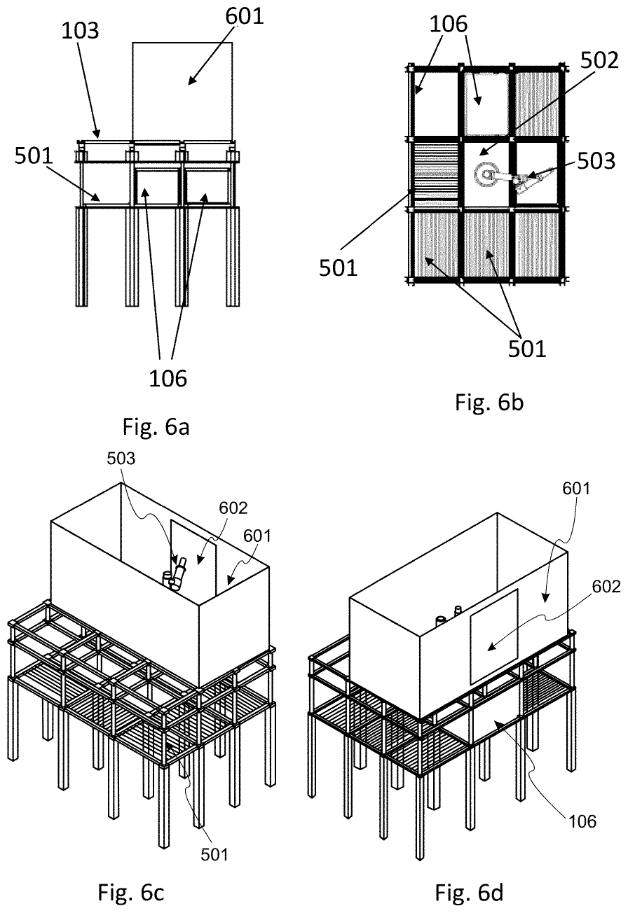

One embodiment of the automated storage and retrieval system according to the invention will now be discussed in more detail with reference to FIGS. 5a-7c FIG. 5a-d is a display of an embodiment of the present invention from different angles. The automated picking system comprises an automated picking arm situated in the access opening of a grid cell that is configured to pick items to and from containers situated in adjacent grid cells, and a conveyor system which is situated in columns of the adjacent grid cells to the automated picking arm for transporting containers to and from a picking zone, a pick-up point and/or a delivery point of the conveyor system of the automated picking system.

In FIG. 5a we see an embodiment of the present invention from the side. On the top we see a robotic arm 503 for picking items from source containers and putting them into target containers. The robotic arm is placed on top of the grid. Just below the grid there are placed containers 106, the containers are standing on a conveyor system. The conveyor system is comprised of individual parts that covers the width and length of a cell. Each part of the conveyor system is controlled by the central computer system. This allows the different parts of the conveyor system to function individually of the other parts. This ensures that the conveyor system has full control of the containers and can manoeuvre the container to into the correct position for picking. In an embodiment of the present invention the containers delivered and picked up at particular places on the conveyor system. These delivering points and pick up points can be the same point of the conveyor system, but they can also be different positions. The delivering point is where the container that comes from the storage and retrieval system is delivered to the conveyor system for being either having items picked from the container or having items placed into the container. If the container is being picked from then the container is a source container and if the container is having items placed into it then it is a target container. The source container is coming from the storage and retrieval system with items stored inside for picking. After the acquired items have been picked from the source container the container is sent to back into the storage and retrieval system or to a different port for further picking. If the container is a target container the container is sent further on in the system for e.g. packing and shipping. In an embodiment of the present invention the target containers are sent to other ports where the items are transported further on for shipping. These other ports can be operated by a human operator or even an automated picking arm.

In FIG. 5b the embodiment of the present invention displayed in FIG. 5a is shown from above. Here it is shown that the different parts of the conveyor system are situated in the access openings of the grid cells surrounding the picking arm. This allows the arm easy access to all the containers on the conveyor system. Further it is possible to see that the different parts of the conveyor system are able to transport the containers into the neighboring cells.

The conveyor system can be either rollers spanning the with or the length of the grid cell. Alternatively, the conveyor system 501 can be belts. In yet another solution the conveyor system can be diagonal rollers that allow moving the containers in two perpendicular directions. This solution allows the container to move in either direction at a corner.

Further it is possible to see that the automated picking arm is placed on a base 502 that spans the access opening of a grid cell. The base can rest on the tracks of the horizontal members 103 on the top of the grid.

FIGS. 5a and 5b is a perspective view of the embodiment of the present invention shown in FIGS. 5a and 5b. Here it can be seen that the automated picking arm and the conveyor system covers an area of 3×3 grid cells. However, in alternative solutions it is possible that the automated picking arm and the conveyor system covers a space of e.g. 5×5 grid cells. In these solutions the automated picking arm is placed at the center of the conveyor system. However, it is also possible to think that the conveyor system covers e.g. 1×3 grid cell or 2×3 grid cells and that the automated picking arm is positioned at the far end of the conveyor system. A bigger conveyor system allows for a system that can handle bigger loads. However, a bigger area also reduces the storage capacity of the storage and retrieval system.

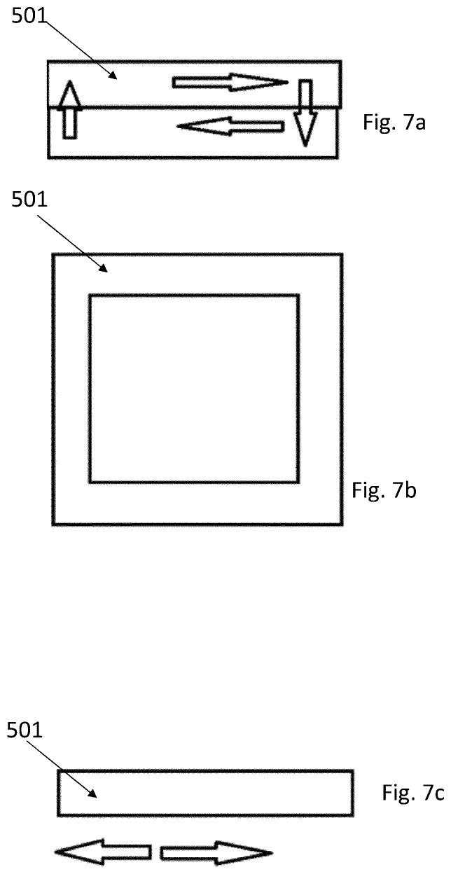

FIG. 6a-d is a display of a different embodiment of the present invention from different angles.

In FIG. 6a it is possible the see a side view of another embodiment of the present invention. In this embodiment part of the conveyor system and the automated picking arm is surrounded walls 601 positioned at the outer edges of the conveyor system in the grid spaces of the picking zone. The picking zone in this embodiment is of 2×3 grid cells. However, larger, or smaller picking zones is possible. The benefit of this solution is that it is possible for personnel to enter the enclosed area and perform maintenance on the system without having to shut down either the entire or parts of the grid. As it can be seen the walls 601 have a door 602 as an entry point for personnel.

The parts of the conveyor system that is placed outside the walls 601 closing of the picking zone is the delivery point and the pickup point of the system.

FIG. 6b-6d gives a display of the embodiment of the present invention mentioned in FIG. 6a. Here it is displayed that the walls of the enclosure have a door 602. Further the walls 601 are the positioned at the outer edges of the conveyor system in the grid spaces of the picking zone. The picking zone is in this embodiment 2×3 grid cells. However, larger and smaller sizes of the picking space is possible.

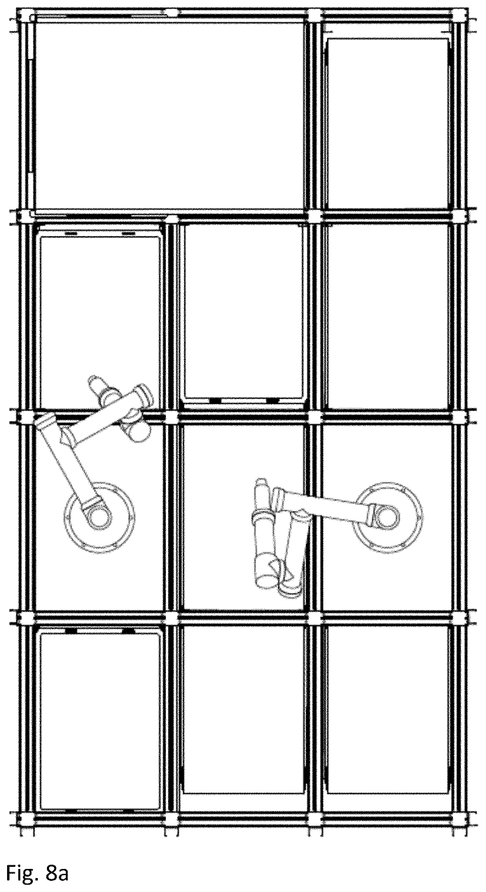

FIG. 7a-c is a display of different solutions to the conveyor system. In FIG. 7a the conveyor system is comprised of two rows of grid cells and the conveyor belt moves in a particular direction. The first (upper) line of the conveyor system moves the container to the right. When it comes to the end the conveyor system moves the container to the second (lower) line of the conveyor system. The second (lower) line of the conveyor system moves the containers to the left. When a container has reached the end of the second conveyor system it is moved to the first (upper) part of the conveyor system.

In FIG. 7b the conveyor system is a square solution, wherein the containers move around the picking arm in one direction.

In FIG. 7c the conveyor system is comprised of one line where the containers can move back and forth in either direction.

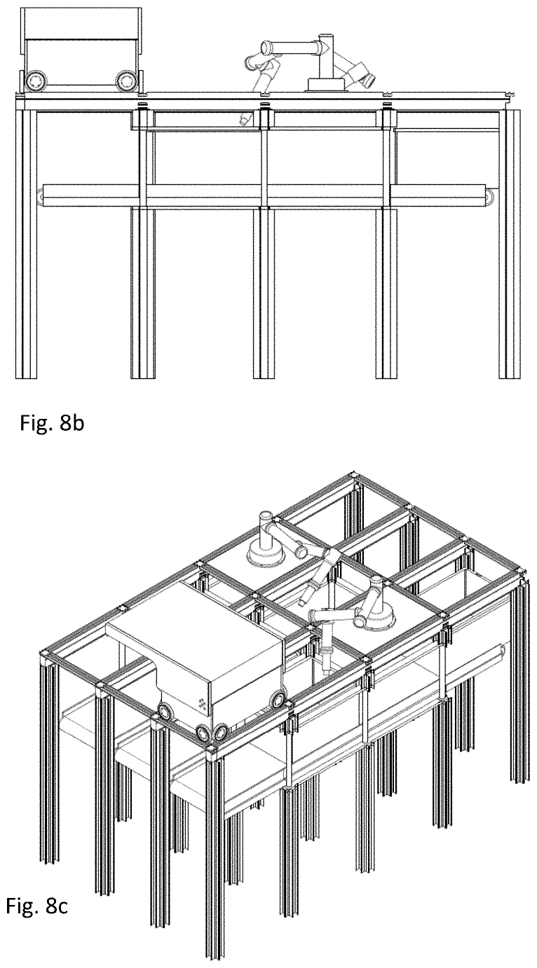

FIG. 8a-c is different view of an alternative embodiment of the present invention wherein there are more than one picking arm.

In this embodiment the present invention regards a solution where there is more than one automated picking arm. This allows for a higher throughput of orders fulfilled than if there is only one picking arm. Here it is also possible to see that there are more parts of the conveyor system in these figures there are 3×4 parts of the conveyor system wherein the line of the conveyor system that is furthest from the picking arms are for delivering and picking up containers.

In yet another solution the conveyor system can be comprised of a first square surrounding a second smaller square. In this solution the first and the second square of conveyor belts or rollers can move in opposite directions.

There can be a stopper at the outer edges of the conveyor system. this stopper would prevent the containers from being moved outside perimeter of the conveyor system. The stopper can be in the form of small blocks placed at regular intervals around the outer perimeter of the conveyor system. Alternatively, the stopper can be in the form of an upright edge running the entire perimeter of the conveyor system.

In an alternative solution of the present invention the conveyor system can be placed at the same level as the automated picking arm. This is on top of the grid. In even another embodiment of the present invention the conveyor system can be placed two levels down from the top of the grid, wherein a level is defied as the height of a container.

In the preceding description, various aspects of the delivery vehicle and the automated storage and retrieval system according to the invention have been described with reference to the illustrative embodiment. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention.

### LIST OF REFERENCE NUMBERS

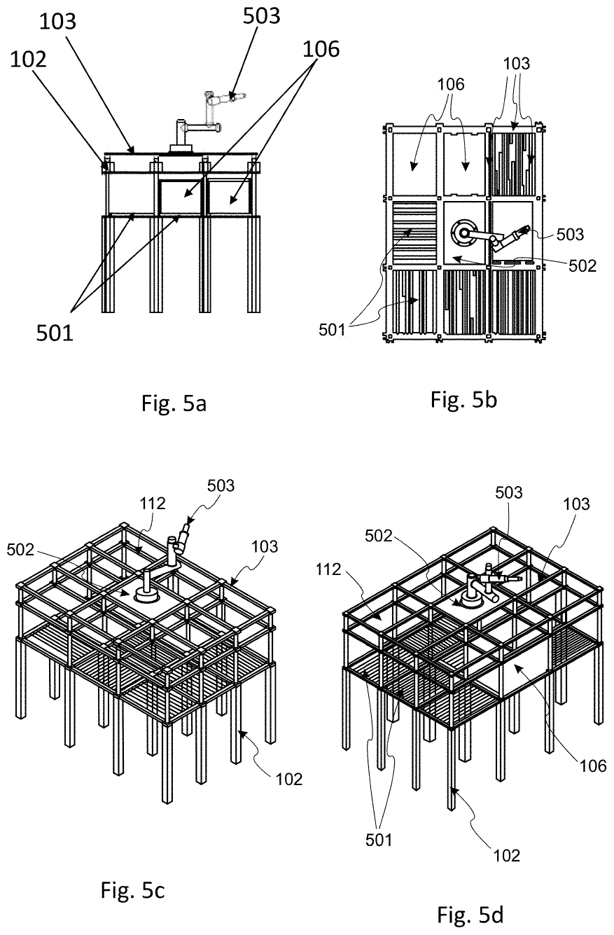

### Prior Art (FIGS. 1-4)

1 Prior art automated storage and retrieval system
100 Framework structure
102 Upright members of framework structure
103 Horizontal members of framework structure
104 Storage grid
105 Storage column
106 Storage container
106′ Particular position of storage container
107 Stack
108 Rail system
110 Parallel rails in first direction (X)
110a First rail in first direction (X)
110b Second rail in first direction (X)
111 Parallel rail in second direction (Y)
111a First rail of second direction (Y)
111b Second rail of second direction (Y)
112 Access opening
119 First port column
120 Second port column
201 Prior art container handling vehicle
201a Vehicle body of the container handling vehicle 201
201b Drive means/wheel arrangement, first direction (X)
201c Drive means/wheel arrangement, second direction (Y)
301 Prior art cantilever container handling vehicle
301a Vehicle body of the container handling vehicle 301
301b Drive means in first direction (X)
301c Drive means in second direction (Y)
401 Prior art container handling vehicle
401a Vehicle body of the container handling vehicle 401
401b Drive means in first direction (X)
401c Drive means in second direction (Y)
501 Conveyor system
502 Base for Automated picking arm
503 Automated picking arm
601 Protective walls
602 Door
Y Second direction
Z Third direction

1. An automated picking system for picking to and from containers in an automated storage and retrieval system wherein the automated storage and retrieval system comprises a rail system comprising a first set of parallel rails arranged to guide movement of a container handling vehicle in a first direction across a frame structure, and a second set of parallel rails arranged perpendicular to the first set of rails to guide movement of the container handling vehicle in a second direction which is perpendicular to the first direction, the first and second sets of parallel rails dividing the rail system into a plurality of grid cells having access openings at a top of the frame structure, for storing storage containers in which items can be stored, the automated picking system comprising:
at least one automated picking arm arranged on a base that spans one or more access openings of a grid cell of the plurality of grid cells that is configured to pick items to and from containers situated in adjacent grid cells of the plurality of grid cells, and
a conveyor system which is situated in columns of the adjacent grid cells to the at least one automated picking arm for transporting containers to and from a picking zone defined by the grid cell occupied by the automated picking system, a pick-up point and/or a delivery point on the top of the frame structure of the conveyor system of the automated picking system.

2. The automated picking system according to claim 1, wherein the automated picking system takes up from 3×3 to 5×5 grid cells.

3. The automated picking system according to claim 1, wherein a picking zone of 2×3 grid cells of the automated picking system is surrounded by walls positioned at outer edges of the conveyor system in the grid cells of the picking zone.

4. The automated picking system according to claim 1, wherein the conveyor system is situated in a stacking level which is located below the access opening of the grid cells.

5. The automated picking system according to claim 1, wherein the conveyor system is situated at a level of the access opening of the grid cells.

6. The automated picking system according to claim 1, wherein the delivery point and the pick-up point of containers are the same grid cell.

7. The automated picking system according to claim 1, wherein the delivery point and the pick-up point of containers are neighboring grid cells.

8. The automated picking system according to claim 1, wherein each grid cell has its own part of the conveyor system that can be controlled independent of other parts of the conveyor system of the other grid cells.

9. The automated picking system according to claim 1, wherein the conveyor system comprises rollers or belts.

10. The automated picking system according to claim 1, wherein the conveyor system is configured to transport the container from one grid cell into a neighboring grid cell.

11. The automated picking system according to claim 1, wherein along an outermost edge of the conveyor system there is positioned stoppers configured to prevent the containers from moving outside the conveyor system.

12. The automated picking system according to claim 11, wherein the stoppers are blocks or an upright edge running an entire perimeter of the conveyor system.

13. The automated picking system according to claim 1, wherein each part of the conveyor system is controlled by a central computer system.

14. The automated picking system according to claim 1, wherein each part of the conveyor system is the size of a grid cell.

15. The automated picking system according to claim 1, wherein the at least one automated picking arm can extend below the access opening of the grid cells.

16. A method for picking at an automated picking system placed for picking to and from containers in an automated storage and retrieval system, wherein the automated storage and retrieval system comprises a rail system comprising a first set of parallel rails arranged to guide movement of a container handling vehicle in a first direction across a frame structure, and a second set of parallel rails arranged perpendicular to the first set of rails to guide movement of the container handling vehicle in a second direction which is perpendicular to the first direction, the first and second sets of parallel rails dividing the rail system into a plurality of grid cells having access openings, for storing storage containers for storing items and wherein the method comprises the following steps:
transporting source containers and/or target containers to a delivering point in the automated picking system using container handling vehicles,
transporting the source container and/or the target container from the delivering point to a picking zone using a conveyor system,
picking one or more items from one or more source containers using at least one automated picking arm,
placing the one or more picked items in the one or more target containers using the at least one automated picking arm,
transporting the source containers and the target containers from the picking zone to a pick-up point when finished using the conveyor system, and
transporting the containers from the pick-up point of the system to a designated area for that container using container handling vehicles.

17. The method according to claim 16, wherein the method includes delivering the source containers back into the frame structure for storage after picking using container handling vehicles.

18. The method according to claim 16 wherein the method includes delivering the target containers to ports for further distribution after picking.

19. The method according to claim 16, wherein the containers are lowered into/raised up through one stacking level onto/off the conveyor system.

20. The method according to claim 16, wherein the containers are lowered into/raised up through two stacking levels onto/off the conveyor system.

21. A computer program product that when executed in a processor by a central computer system is arranged to control at least one picking arm and a conveyor system for picking at an automated picking system placed for picking to and from containers in an automated storage and retrieval system to perform the steps of:
transporting a container from the automated storage and retrieval system to the conveyor system using a container handling vehicle,
maneuvering the container to a right position in the automated picking system using the conveyor system,
using the at least one picking arm to pick an item stored in a source container and deliver it to a target container, and
using a container handling vehicle to pick up the source container after the item has been picked.

22. An automated storage and retrieval system comprising:
a framework structure with a rail system comprising a first set of parallel rails arranged to guide movement of a container handling vehicle in a first direction across the framework structure, and a second set of parallel rails arranged perpendicular to the first set of rails to guide movement of the container handling vehicle in a second direction which is perpendicular to the first direction, the first and second sets of parallel rails dividing the rail system into a plurality of grid cells having access openings, for storing storage containers in which items can be stored, forming vertical columns each having a horizontal area defined by a size of an access opening between rails of the rail system (108) that are arranged on the framework structure,
an automated picking system comprising at least one automated picking arm situated in the access opening of a grid cell that is configured to pick items to and from containers situated in adjacent grid cells, and
a conveyor system which is situated in columns of the adjacent grid cells to the at least one automated picking arm for transporting containers to and from a picking zone, a pick-up point and/or a delivery point of the conveyor system of the automated picking system;
wherein the automated storage and retrieval system is controlled by a central computer system.
